(19) United States
(12) Patent Application Publication
(10) Pub. No.: US 2021/0380096 A1
(43) Pub. Date: Dec. 9, 2021

(54) VEHICLE CONTROL DEVICE, ROUTE DISTRIBUTION DEVICE, VEHICLE GUIDANCE SYSTEM

(71) Applicant: HITACHI ASTEMO, LTD., Ibaraki (JP)

(72) Inventors: Shunsuke KATOH, Hitachinaka-shi, Ibaraki (JP); Katsuro WATANABE, Hitachinaka-shi, Ibaraki (JP)

(73) Assignee: HITACHI ASTEMO, LTD., Ibaraki (JP)

(21) Appl. No.: 17/288,076

(22) PCT Filed: Oct. 23, 2019
(86) PCT No.: PCT/JP2019/041447

§ 371 Date: Apr. 23, 2021

(30) Foreign Application Priority Data
Nov. 8, 2018 (JP) 2018-210635

(51) Int. Cl. B60W 30/06; G07C 5/08

(52) U.S. Cl. CPC B60W 30/06; B60W 2556/50; G07C 5/085

(57) ABSTRACT

The invention provides a technique capable of flexibly changing a parking position and a traveling route when guiding a vehicle to a parking position. A vehicle control device according to the invention transmits vehicle data representing a physical state of the vehicle, and receives virtual parking frame data and traveling route data corresponding to the vehicle data, which are repeated until parking is completed.

### TECHNICAL FIELD

The present invention relates to a technique for automatically parking a vehicle.

### BACKGROUND ART

In some commercial facilities, parking spaces are located away from the facility. In this case, visitors must travel a considerable distance between the facility and the parking space. Therefore, in such a commercial facility, a parking agency service called a valet parking service may be used. However, in recent years, there has been an increasing need for automating valet parking services in order to improve the management efficiency of parking spaces (occupancy rate, parking efficiency, labor costs, etc.).

The following PTL 1 describes automatic parking in a parking lot. The document has an object, “the vehicle is guided accurately in the parking lot”, and states “the vehicle guidance device 2 includes a guidance controller 40 that generates a command signal for guiding the vehicle 1 based on map information,

a current position calculation unit 43 that calculates the current position of the vehicle 1 based on the detection signal of a detector mounted in the vehicle 1, a marker recognition unit 6 that recognizes a marker 20 from the peripheral image captured by the camera 3, an actual current position calculation unit 7 that calculates the current position of the vehicle 1 based on the marker 20 recognized by the marker recognition unit 6, and a correction command unit 44 that generates a correction command for correcting the position of the vehicle 1 based on a difference between the current position of the vehicle 1 calculated by the current position calculation unit 43 and the current position of the vehicle 1 calculated by the actual current position calculation unit 7. The guidance controller 40 guides the vehicle 1 based on the command signal and the correction command” (see ABSTRACT).

### CITATION LIST

### Patent Literature

PTL 1: JP 2017-117188 A

### SUMMARY OF INVENTION

### Technical Problem

In the technique described in PTL 1, the traveling route on which the vehicle can travel and the parking frame in which the vehicle parks are defined as different areas from each other. Therefore, in the same document, it is considered that the vehicle is premised on traveling in an area defined as the traveling route. In other words, it is not expected that the vehicle will travel in an area defined as a parking frame.

On the other hand, some of the actual parking spaces are close to free spaces because the parking frame is not predetermined. In such a parking space, it is sufficient if the vehicles can be parked in line, and it is not necessary to distinguish between the parking frame and the traveling route. When the technique described in PTL 1 is used in such a parking space, the vehicle is guided in the free space after defining the parking frame and the traveling route in advance. However, in the free space, it is not necessary to distinguish the parking frame from the traveling route in advance, so such a method may impair the flexibility of the traveling route. This increases the possibility of problems such as traffic jams in the parking space.

The invention has been made in view of the above problems, and an object of the invention is to provide a technology capable of flexibly changing a parking position and a traveling route when guiding a vehicle to a parking position.

### Solution to Problem

A vehicle control device according to the invention repeatedly transmits vehicle data representing a physical state of a vehicle, and receives traveling route data corresponding to the vehicle data until the vehicle completely parks in a virtual parking frame.

### Advantageous Effects of Invention

According to the vehicle control device of the invention, by repeatedly receiving the traveling route data, it is possible to flexibly change a parking position and a traveling route toward a parking position until the parking is completed. Further, by defining a virtual parking frame, the traveling route can be flexibly defined without distinguishing between the traveling route and the parking frame.

### BRIEF DESCRIPTION OF DRAWINGS

FIG. 1 is a configuration diagram of a vehicle guidance system 10 according to a first embodiment.

FIG. 2 is an array of points described by map data.

FIG. 3 is a flowchart for explaining the operation of a vehicle control device 100.

FIG. 4 is a flowchart illustrating the operation of a route distribution device 200.

FIG. 5 is a configuration diagram of the route distribution device 200 according to a second embodiment.

FIG. 6A illustrates a scene in which a vehicle and the vehicle control device 100 equipped with the vehicle are trying to park in a parking space.

FIG. 6B illustrates an example in which traveling routes overlap between vehicles.

FIG. 6C illustrates a scene in which a plurality of vehicles are about to leave at the same timing.

### DESCRIPTION OF EMBODIMENTS

### First Embodiment

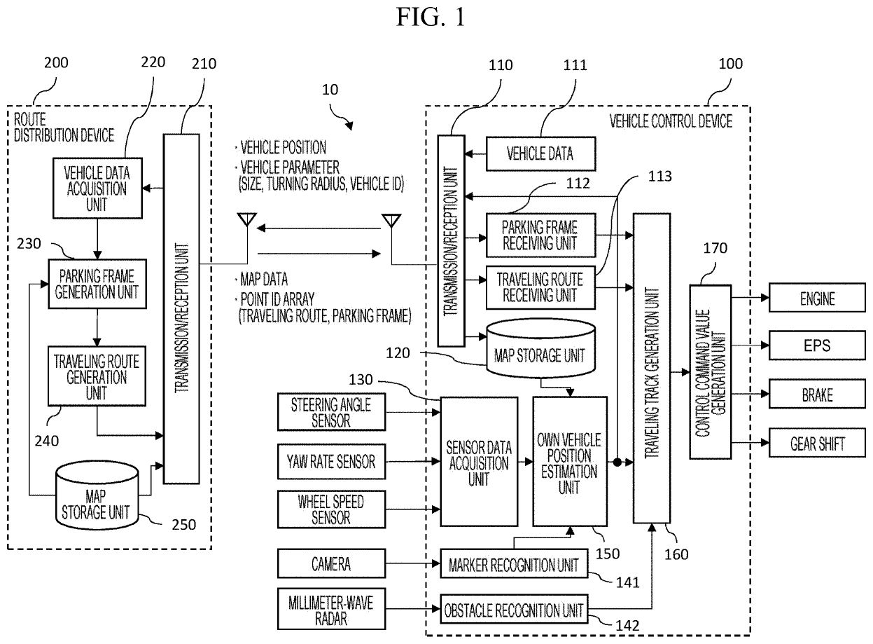

FIG. 1 is a configuration diagram of a vehicle guidance system 10 according to a first embodiment of the invention. The vehicle guidance system 10 is a system that automatically parks a vehicle by guiding the vehicle to a parking position in a parking space. This parking space may have a parking frame set in advance, or may be close to a free space in which the parking frame is not specified in advance. In the following, a parking space close to a free space is assumed.

The vehicle guidance system 10 includes a vehicle control device 100 and a route distribution device 200. The vehicle control device 100 is an electronic control device mounted on a vehicle parked in a parking space, and automatically parks the vehicle in the parking space by controlling the operation of the vehicle. The route distribution device 200 is a device that guides the vehicle to the parking position by transmitting a command to the vehicle control device 100. The vehicle control device 100 and the route distribution device 200 can transmit and receive data by wireless communication.

The vehicle control device 100 includes a transmission/reception unit 110 (command receiving unit), a map storage unit 120, a sensor data acquisition unit 130, a marker recognition unit 141, an obstacle recognition unit 142, an own vehicle position estimation unit 150, a traveling track generation unit 160, and a control command value generation unit 170.

The transmission/reception unit 110 transmits/receives data to/from the route distribution device 200 by wireless communication.

The transmission/reception unit 110 transmits vehicle data 111 to the route distribution device 200. The contents of the vehicle data 111 will be described later. The transmission/reception unit 110 further includes a parking frame receiving unit 112 and a traveling route receiving unit 113. The parking frame receiving unit 112 receives virtual parking frame data describing the coordinates of a virtual parking frame in the parking space from the route distribution device 200. The traveling route receiving unit 113 receives traveling route data, which describes a route in which the vehicle travels toward the virtual parking frame in the parking space, from the route distribution device 200. The virtual parking frame will be described later.

The map storage unit 120 is a device that stores map data describing the coordinates of each point in the parking space. Each point described in the map data may be referred to as a point in the following. The map data describes the ID for distinguishing each point and the coordinates of each point. The map data can be stored in the map storage unit 120 in advance, or can be received from the route distribution device 200 and stored in the map storage unit 120.

The sensor data acquisition unit 130 acquires measured values from each sensor mounted on the vehicle. For example, the measured value is acquired from a sensor such as a steering angle sensor that measures the steering angle of the steering wheel, a yaw rate sensor that measures the yaw rate of the vehicle, and a wheel side sensor that measures the wheel speed.

The marker recognition unit 141 recognizes a marker installed in the parking space by using an image captured by a camera mounted on the vehicle. As the marker, for example, a shape pattern drawn on the road surface, an installation object having a unique shape, or the like can be used. The obstacle recognition unit 142 recognizes an obstacle that hinders the traveling of the vehicle in the parking space by using a millimeter-wave radar or the like mounted on the vehicle. An example of an obstacle is an object falling on the road surface.

The own vehicle position estimation unit 150 estimates the current position of the vehicle according to the measured value acquired by the sensor data acquisition unit 130. In addition to this, the own vehicle position estimation unit 150 can correct the estimation result by using the position and orientation of the marker recognized by the marker recognition unit 141.

The traveling track generation unit 160 calculates a track for the vehicle traveling toward the virtual parking frame in the parking space according to the virtual parking frame data and the traveling route data. This traveling track may include a track for moving the vehicle to the virtual parking frame and a traveling track for adjusting the posture when the vehicle is parked in the virtual parking frame. Further, when the obstacle recognition unit 142 recognizes an obstacle, the traveling track generation unit 160 can finely modify the traveling track such that the vehicle does not collide with the obstacle within a range not deviating from the traveling route designated by the virtual parking frame data and the traveling route data.

The control command value generation unit 170 (traveling control unit) generates a control command value for each part of the vehicle so that the vehicle travels according to the travel track generated by the traveling track generation unit 160. For example, command values can be transmitted to engines, EPS (electric power steering system), brakes, gear shifts, and the like.

The route distribution device 200 can be configured by, for example, a server computer installed in a control center that provides a parking service. The route distribution device 200 includes a transmission/reception unit 210 (command transmitting unit), a vehicle data acquisition unit 220, a parking frame generation unit 230, a traveling route generation unit 240, and a map storage unit 250.

The transmission/reception unit 210 transmits/receives data to/from the vehicle control device 100 by wireless communication.

The transmission/reception unit 210 receives the vehicle data 111 from the vehicle control device 100, and transmits the map data/virtual parking frame data/traveling route data to the vehicle control device 100.

The vehicle data acquisition unit 220 acquires the vehicle data 111. The vehicle data 111 includes the current position of the vehicle and vehicle parameters. The vehicle control device 100 repeatedly transmits, for example, the current position of the vehicle to the route distribution device 200 at predetermined time intervals. The vehicle data acquisition unit 220 repeatedly acquires the vehicle position. The vehicle parameter is a parameter representing the physical state of the vehicle, and can be used when determining the traveling route of the vehicle. For example, the three-dimensional size of the vehicle, the turning radius, etc. can be considered. In addition to this, an ID for identifying the vehicle may be included in the vehicle parameters. The vehicle parameters do not necessarily have to be transmitted and received repeatedly.

The parking frame generation unit 230 generates a virtual parking frame in which the vehicle parks in the parking space.

For example, an appropriate virtual parking frame can be determined according to the size of the parking space and the number of vehicles. When the parking space does not have an actual parking frame, this virtual parking frame is a virtual one defined by the parking frame generation unit 230 determining the coordinates of the parking position. The parking frame generation unit 230 can determine a virtual parking frame according to the vehicle parameters. For example, a virtual parking frame of a size sufficient for the vehicle to park can be determined according to the size of a vehicle.

The traveling route generation unit 240 generates a route for the vehicle to travel from the current position to the virtual parking frame. When the parking space is a free space, it is not necessary to make a strict distinction between the traveling route and the parking frame. Therefore, the traveling route generation unit 240 can also designate an area designated as a virtual parking frame for a certain vehicle as a traveling route for another vehicle. This makes it possible to flexibly define the traveling route. The traveling route generation unit 240 can determine the traveling route according to the vehicle parameters. For example, a traveling route can be generated according to the size and turning radius of the vehicle so that the vehicle can pass with sufficient margin.

The map storage unit 250 is a device that stores map data describing the ID and coordinates of each point in the parking space. This map data may be the same as that held by the vehicle control device 100, or the sequentially updated map data may be stored in the map storage unit 250 and distributed to the vehicle control device 100.

The virtual parking frame data and the traveling route data can be described as a point array on the map data. Specifically, it can be described as an array of point IDs. As the traveling route data, it is not always necessary to transmit the coordinates of all the points in the parking space to the vehicle control device 100. It is sufficient to transmit at least the traveling route data from the current position of the vehicle to the virtual parking frame.

The parking frame generation unit 230 and the traveling route generation unit 240 repeatedly generate the virtual parking frame data and the traveling route data, respectively. The transmission/reception unit 210 repeatedly transmits the virtual parking frame data and the traveling route data to the vehicle control device 100. As a result, the parking position and the traveling route toward the parking position can be flexibly changed.

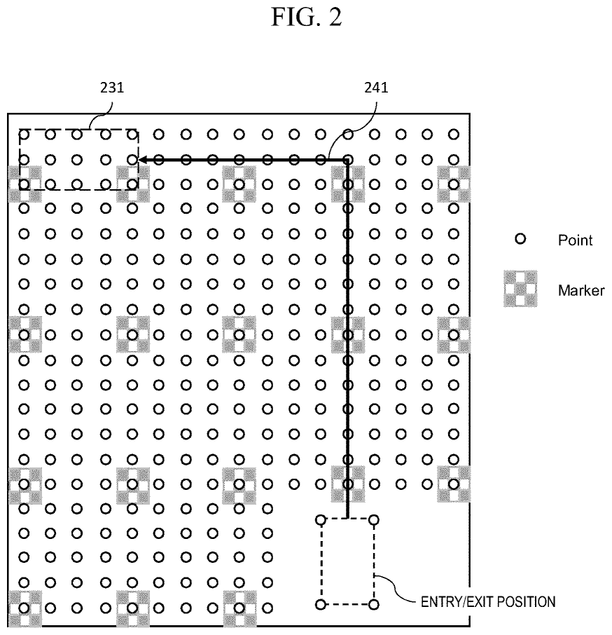

FIG. 2 is an array of points described by the map data. Here, the map data of a parking space in which a parking frame is not defined in advance is illustrated. The map data describes the ID/coordinates of each point in the parking space. If the markers are installed in the parking space, the map data can also describe the coordinates of each marker.

The driver of the vehicle drives the vehicle to the entry position and gets off the vehicle. The parking frame generation unit 230 generates a virtual parking frame 231, and the traveling route generation unit 240 generates a traveling route 241 from the entry position to the virtual parking frame 231. Each of these can be described as a point array in the parking space. The same applies to the traveling route and the stop position from the virtual parking frame 231 to the exit position.

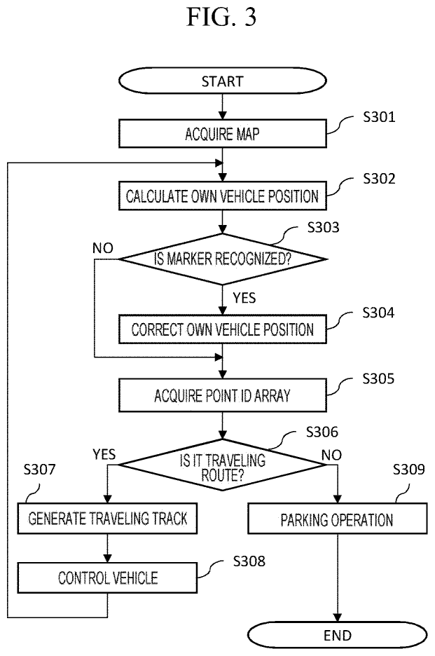

FIG. 3 is a flowchart for explaining the operation of the vehicle control device 100. Hereinafter, each step of FIG. 3 will be described.

### (FIG. 3: Step S301)

The transmission/reception unit 110 receives the map data of the parking space from the route distribution device 200 and stores it in the map storage unit 120. If the map storage unit 120 already holds the latest map data of the parking space, this step may be omitted.

### (FIG. 3: Steps S302 to S304)

The own vehicle position estimation unit 150 estimates the current position of the vehicle (S302). When the marker recognition unit 141 recognizes the marker in the vicinity of the vehicle (S303: YES), the own vehicle position estimation unit 150 corrects the own vehicle position according to the recognition result (S304).

### (FIG. 3: Step S305)

The transmission/reception unit 110 acquires a point ID array in the parking space from the route distribution device 200. This point ID array corresponds to virtual parking frame data or traveling route data. The route distribution device 200 may distribute the virtual parking frame data and the traveling route data together, or distributes only the traveling route data until the vehicle reaches the virtual parking frame. When the virtual parking frame is reached, the virtual parking frame data may be distributed. FIG. 3 describes an example of the latter.

### (FIG. 3: Steps S306 to S308)

When the transmission/reception unit 110 receives the traveling route data (S306: YES), the traveling track generation unit 160 generates a traveling track in the parking space according to the traveling route data (S307). The control command value generation unit 170 controls each part of the vehicle according to the traveling track (S308). After Step S308, the process returns to Step S302 and the same process is repeated.

### (FIG. 3: Steps S306 to S309)

When the transmission/reception unit 110 receives the virtual parking frame data (S306: NO), the traveling track generation unit 160 and the control command value generation unit 170 park the vehicle in the virtual parking frame. Specifically, the orientation and position of the vehicle are controlled so that the vehicle fits within the virtual parking frame according to the position and orientation of the virtual parking frame.

### (FIG. 3: Steps S305 to S309: Supplement 1)

When the route distribution device 200 distributes the virtual parking frame data and the traveling route data together, S307 to S308 are executed until the vehicle reaches the virtual parking frame, and S309 is executed when the virtual parking frame is reached. Whether the vehicle has reached the virtual parking frame can be determined by comparing the coordinates of the virtual parking frame with the own vehicle position.

### (FIG. 3: Steps S305 to S309: Supplement 2)

When the route distribution device 200 distributes the virtual parking frame data and the traveling route data together, the virtual parking frame can be changed after the virtual parking frame data is once transmitted. When the virtual parking frame data is transmitted when the vehicle reaches the end of the traveling route, the amount of data can be suppressed.

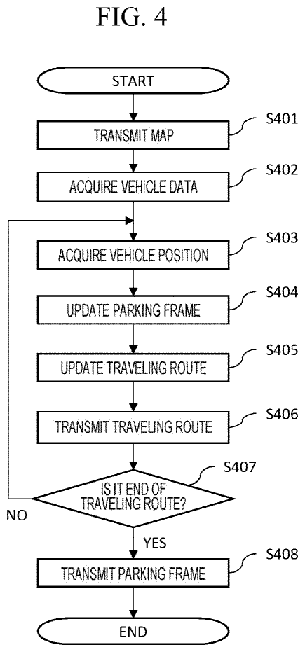

FIG. 4 is a flowchart for explaining the operation of the route distribution device 200. FIG. 4 illustrates an example in which only the traveling route data is transmitted until the vehicle reaches the virtual parking frame, and the virtual parking frame data is transmitted when the vehicle reaches the virtual parking frame. Hereinafter, each step of FIG. 4 will be described.

### (FIG. 4: Steps S401 to S403)

The transmission/reception unit 210 transmits the map data of the parking space to the vehicle control device 100 (S401). The transmission/reception unit 210 and the vehicle data acquisition unit 220 acquire vehicle data 111 from the vehicle control device 100 (S402). At the time of Step S402, only the vehicle parameters may be acquired, or the vehicle position may be acquired in addition to the vehicle parameter. The transmission/reception unit 210 acquires the current position of the vehicle from the vehicle control device 100 (S403).

### (FIG. 4: Steps S404 and S405)

The parking frame generation unit 230 and the traveling route generation unit 240 update the virtual parking frame data (S404) and the traveling route data (S405), respectively, according to the vehicle parameter and the current position of the vehicle. Since the traveling route data represents the route from the current position of the vehicle to the virtual parking frame, it is necessary to update the traveling route data every time the vehicle position is updated. For example, when changing the parking position according to the degree of congestion of the parking space, it is meaningful to update the virtual parking frame data.

Similarly, it is meaningful to change the traveling route data according to the degree of congestion.

### (FIG. 4: Steps S406 and S407)

The transmission/reception unit 210 transmits the traveling route data from the current position of the vehicle to the virtual parking frame to the vehicle control device 100 (S406). It is not always necessary to transmit the entire route between the entry/exit position and the virtual parking frame. If the vehicle has not reached the end of the traveling route (that is, the virtual parking frame), the process returns to Step S403 and the same process is repeated (S407: NO).

### (FIG. 4: Step S408)

The transmission/reception unit 210 transmits the virtual parking frame data to the vehicle control device 100. This step completes the process of guiding one vehicle to the virtual parking frame. When guiding a plurality of vehicles, this flowchart is implemented for each vehicle.

### First Embodiment: Summary

The vehicle control device 100 according to the first embodiment receives virtual parking frame data describing a virtual parking frame in a parking space from the route distribution device 200. The virtual parking frame is a virtual one defined by the coordinates on the parking space. Therefore, the vehicle can travel on a flexible route without strictly distinguishing between the parking frame and the traveling route. As a result, it is possible to reduce the risk of causing traffic congestion of vehicles and provide an efficient automatic valet parking service, especially in a free space where a parking frame is not defined in advance.

The vehicle control device 100 according to the first embodiment repeatedly receives the traveling route data corresponding to the vehicle data until it reaches the virtual vehicle frame. As a result, even if the traveling route is once determined, the traveling route can be flexibly changed according to the situation such as the degree of congestion of the parking space. Similarly, the virtual vehicle frame data can be repeatedly received.

As a result, even if the parking position is once determined, the parking position can be flexibly changed in the same manner.

### Second Embodiment

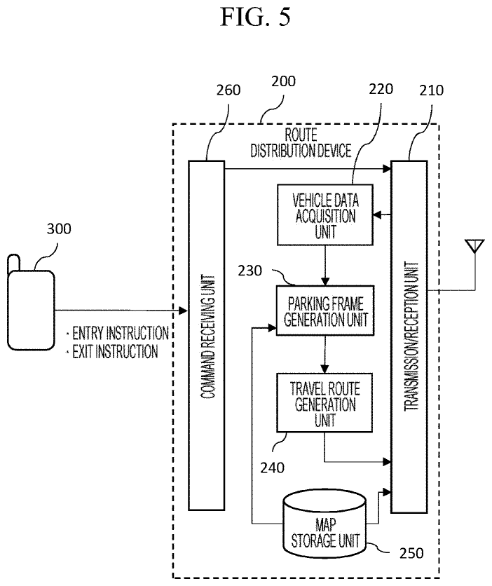

FIG. 5 is a configuration diagram of the route distribution device 200 according to the second embodiment of the invention. Since the configuration of the route distribution device 200 is the same as that of the first embodiment, the differences will be mainly described below. The route distribution device 200 further includes a command receiving unit 260 that receives a command from a user terminal 300.

The driver of the vehicle gets off the vehicle after driving the vehicle to the entry position. The driver transmits a command for instructing the vehicle to be parked to the route distribution device 200 via the user terminal 300. The command receiving unit 260 receives the command. The transmission/reception unit 210 receives vehicle data 111 from the vehicle in accordance with the command. Subsequent operations are the same as in the first embodiment.

When the driver of the vehicle leaves the parking space, the driver of the vehicle also transmits the fact of the command to the route distribution device 200 via the user terminal 300. When the command receiving unit 260 receives the command, the route distribution device 200 generates a traveling route from the virtual parking frame to the exit position as in the case of the entry. In this case, the exit position may be handled in the same way as the virtual parking frame. Subsequent operations are the same as in the first embodiment.

The entry command and the exit command each can be specified with the date and time. In this case, when the route distribution device 200 reaches the designated date and time, the vehicle is instructed to enter or leave. The user terminal 300 can be configured by using a mobile terminal such as a smartphone or a tablet computer.

### Third Embodiment

In the third embodiment of the invention, an example of the operation in which, when the traveling routes overlap between vehicles, the traveling route is regenerated to avoid traffic congestion will be described. The configuration of the vehicle guidance system 10 is the same as that of the first and second embodiments.

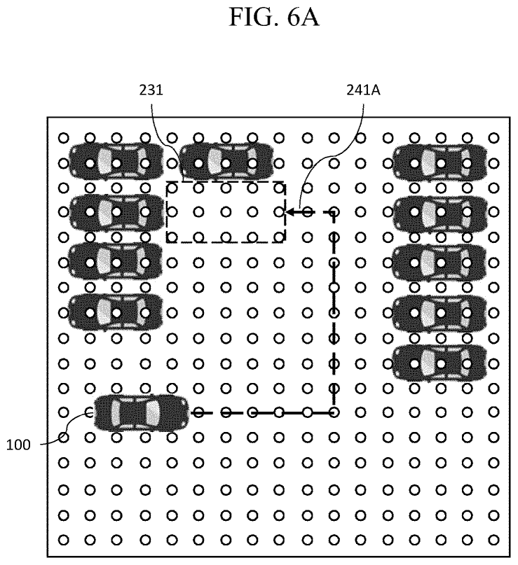

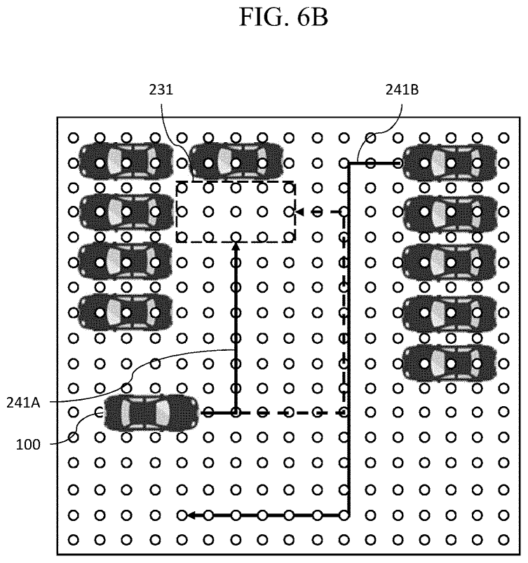

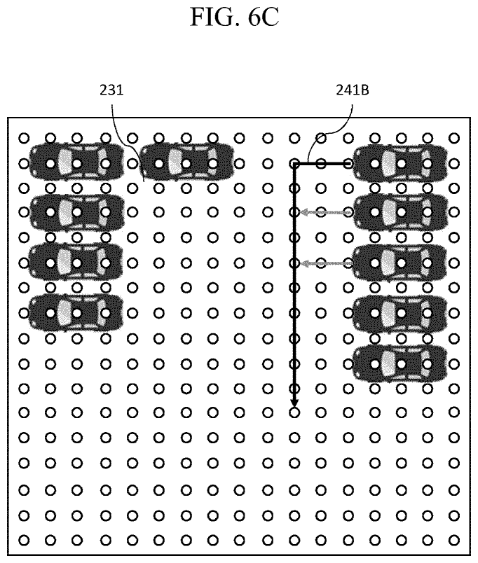

FIG. 6A illustrates a scene in which the vehicle and the vehicle control device 100 equipped in the vehicle are trying to park in the parking space. The parking space in FIG. 6A is the same as that described in FIG. 2, but for convenience of description, the marker and the entry/exit position are omitted. In FIG. 6A, it is assumed that the virtual parking frame 231 and a traveling route 241A are designated as illustrated in the drawing.

FIG. 6B illustrates an example in which traveling routes overlap between vehicles. In the scene illustrated in FIG. 6A, it is assumed that a traveling route 241B is specified for another vehicle to leave the parking lot. Since the traveling route 241B partially overlaps with the traveling route 241A in FIG. 6A, if each vehicle travels as it is, there is a possibility that the vehicles collide with each other. Therefore, when the traveling routes overlap between the vehicles, the traveling route generation unit 240 regenerates the traveling route data of at least one of the vehicles so that the traveling routes do not overlap between the vehicles. Specifically, each traveling route may not include the same point ID. The overlapping may be avoided by other appropriate methods. In FIG. 6B, the traveling route 241A has been changed from the dotted line to the solid line.

FIG. 6C illustrates a scene in which the plurality of vehicles are about to leave the parking lot at the same timing. Even if the traveling routes do not overlap, there is a possibility that the vehicles may collide depending on the timing of travel. Therefore, the transmission/reception unit 210 may transmit a start command or a stop command together with the virtual parking frame data/traveling route data to be transmitted to each vehicle. The start command or the stop command itself may be transmitted, or the transmission of the virtual parking frame data/traveling route data may be regarded as the start command and the empty virtual parking frame data/traveling route data may be regarded as the stop command. Similar commands may be transmitted by other appropriate methods.

The vehicle control device 100 (control command value generation unit 170) starts the vehicle when it receives the start command, and stops the vehicle on the spot when it receives the stop command. As a result, it is possible to prevent vehicles from colliding with each other even in the scene illustrated in FIG. 6C.

### Modifications of Invention

The invention is not limited to the above embodiments, but various modifications may be contained. For example, the above-described embodiments of the invention have been described in detail in a clearly understandable way, and are not necessarily limited to those having all the described configurations. In addition, some of the configurations of a certain embodiment may be replaced with the configurations of the other embodiments, and the configurations of the other embodiments may be added to the configurations of the subject embodiment. In addition, some of the configurations of each embodiment may be omitted, replaced with other configurations, and added to other configurations.

In the above embodiment, the functions of either or both of the parking frame generation unit 230 and the traveling route generation unit 240 can be arranged in the vehicle control device 100. When the traveling route generation unit 240 is arranged in the vehicle control device 100, the vehicle control device 100 receives only the virtual parking frame data, and the vehicle control device 100 generates the traveling route to the virtual parking frame. The traveling route for avoiding a collision between vehicles can be spontaneously generated by each vehicle, for example, by notifying each other of the vehicle position and the traveling route by communication between the vehicles.

Similarly, when the parking frame generation unit 230 is arranged in the vehicle control device 100, it is possible to prevent the parking positions and traveling routes from overlapping by communicating between the vehicles.

In the above embodiment, the example of transmitting the traveling route data and the virtual parking frame data to the vehicle control device 100 has been described, but it is also possible to transmit only the traveling route data and regard the end of the traveling route as the virtual parking frame. In this case, the posture when the vehicle is parked can be determined by the vehicle control device 100 by using a peripheral image of the vehicle or the like.

Each of the above configurations, functions, processing units, processing means, and the like may be partially or entirely achieved by hardware by, for example, designing by an integrated circuit. In addition, the configurations and the functions may be realized in software such that a processor analyzes and performs a program which realizes each function. The information of programs, tables, files to realize the functions may be stored in a memory, a recording device such as a hard disk, an SSD (Solid State Drive), or a recording medium such as an IC card and an SD card. In addition, only control lines and information lines considered to be necessary for explanation are illustrated, but not all the control lines and the information lines for a product are illustrated. In practice, almost all the configurations may be considered to be connected to each other.

### REFERENCE SIGNS LIST

10 vehicle guidance system
100 vehicle control device
111 vehicle data
112 parking frame receiving unit
113 traveling route receiving unit
120 map storage unit
160 traveling track generation unit
170 control command value generation unit
200 route distribution device
210 transmission/reception unit
220 vehicle data acquisition unit
230 parking frame generation unit
240 traveling route generation unit
250 map storage unit
260 command receiving unit

1. A vehicle control device for controlling an operation of a vehicle, comprising:
a map storage unit that stores map data describing a map of a parking space in which the vehicle parks;
a vehicle data storage unit that stores vehicle data describing a physical state of the vehicle;
a transmission unit that transmits the vehicle data to the outside of the vehicle;
a virtual parking frame receiving unit that receives virtual parking frame data describing a position of a virtual parking frame on the map data corresponding to the vehicle data; and
a traveling route receiving unit that receives first traveling route data describing a traveling route of the vehicle in the parking space corresponding to coordinates of the virtual parking frame,
wherein the traveling route receiving unit repeatedly receives the first traveling route data between a time when the vehicle starts traveling toward the virtual parking frame in the parking space and a time when the vehicle parks in the virtual parking frame.

2. The vehicle control device according to claim 1,
wherein the map data describes coordinates and an ID of a point in the parking space,
wherein the virtual parking frame data is configured to specify a position of the virtual parking frame by specifying an ID of the point, and
wherein the first traveling route data is configured to specify a traveling route of the vehicle in the parking space by specifying an ID of the point.

3. The vehicle control device according to claim 1,
wherein, after receiving the first traveling route data, the traveling route receiving unit receives second traveling route data describing a traveling route of the vehicle in the parking space corresponding to the coordinates of the virtual parking frame until the vehicle parks in the virtual parking frame, and
wherein, when the second traveling route data describes a traveling route different from the first traveling route data in the parking space, the traveling route receiving unit overwrites the first traveling route data with the second traveling route data.

4. The vehicle control device according to claim 1, further comprising:
a traveling control unit that controls an operation of the vehicle in the parking space according to the virtual parking frame data and the first traveling route data so as to park the vehicle in the virtual parking frame.

5. The vehicle control device according to claim 4, further comprising:
a command receiving unit that receives a command for instructing the vehicle to start or stop,
wherein the traveling control unit starts the vehicle toward the virtual parking frame or stops the vehicle according to the command received by the command receiving unit.

6. The vehicle control device according to claim 4, further comprising:
a command receiving unit that receives a command for instructing the vehicle to park in or depart from the virtual parking frame,
wherein the traveling control unit causes the vehicle to travel toward or depart from the virtual parking frame in accordance with the command received by the command receiving unit.

7. The vehicle control device according to claim 1,
wherein the transmission unit transmits a size of the vehicle and a turning radius of the vehicle as the vehicle data, and
wherein the traveling route receiving unit receives, as the first traveling route data, a traveling route that allows the vehicle to reach the virtual parking frame according to the size of the vehicle and the turning radius of the vehicle.

8. The vehicle control device according to claim 1,
wherein the transmission unit repeatedly transmits a current position of the vehicle as the vehicle data until the vehicle reaches the virtual parking frame, and
wherein the traveling route receiving unit receives a traveling route from the current position of the vehicle to the virtual parking frame as the first traveling route data.

9. A route distribution device for distributing a traveling route in a parking space in which a vehicle parks, comprising:
a map storage unit that stores map data describing a map of the parking space;
a reception unit that receives vehicle data describing a physical state of the vehicle;
a virtual parking frame transmitting unit that transmits virtual parking frame data describing a position of a virtual parking frame on the map data corresponding to the vehicle data to the vehicle; and
a traveling route transmitting unit that transmits traveling route data describing a traveling route of the vehicle in the parking space corresponding to coordinates of the virtual parking frame to the vehicle,
wherein the traveling route transmitting unit repeatedly transmits the traveling route data to the vehicle between a time when the vehicle starts traveling toward the virtual parking frame in the parking space and a time when the vehicle parks in the virtual parking frame.

10. The route distribution device according to claim 9,
wherein the map data describes coordinates and an ID of a point in the parking space,
wherein the virtual parking frame data is configured to specify a position of the virtual parking frame by specifying an ID of the point, and
wherein the traveling route data is configured to specify a traveling route of the vehicle in the parking space by specifying an ID of the point.

11. The route distribution device according to claim 9, further comprising:
a traveling route generation unit that generates the traveling route data according to the vehicle data,
wherein the reception unit receives the vehicle data from a plurality of vehicles, and
wherein, when the reception unit receives first vehicle data describing a state of a first vehicle and then the reception unit receives second vehicle data describing a state of a second vehicle, the traveling route generation unit generates first traveling route data describing a first traveling route in which the first vehicle travels in the parking space according to the first vehicle data, and generates a second traveling route data describing a second traveling route in which the second vehicle travels in the parking space according to the second vehicle data.

12. The route distribution device according to claim 11,
wherein, when the first traveling route of the first vehicle described by the first traveling route data and the second traveling route of the second vehicle described by the second traveling route data overlap in the parking space, the traveling route generation unit regenerates at least any one of the first traveling route data and the second traveling route data such that the first traveling route and the second traveling route do not overlap, and
wherein the traveling route transmitting unit retransmits the regenerated first traveling route data or the second traveling route data.

13. The route distribution device according to claim 9, further comprising:
a command transmitting unit that transmits a command to the vehicle,
wherein the command transmitting unit transmits the command for instructing the vehicle to start or stop, and the command transmitting unit transmits the command for instructing the vehicle to park in the virtual parking frame or depart from the virtual parking frame.

14. The route distribution device according to claim 9,
wherein the reception unit receives a size of the vehicle and a turning radius of the vehicle as the vehicle data,
wherein the reception unit repeatedly receives a current position of the vehicle as the vehicle data until the vehicle reaches the virtual parking frame,
the route distribution device further comprises a traveling route generation unit that generates the traveling route data according to the vehicle data,
wherein the traveling route generation unit generates the traveling route data that allows the vehicle to reach the virtual parking frame according to the size of the vehicle and the turning radius of the vehicle, and
wherein the traveling route generation unit generates a traveling route from the current position of the vehicle to the virtual parking frame.

15. (canceled)

16. A vehicle guidance system, comprising:
a vehicle control device for controlling an operation of a vehicle, comprising:
a map storage unit that stores map data describing a map of a parking space in which the vehicle parks;
a vehicle data storage unit that stores vehicle data describing a physical state of the vehicle;
a transmission unit that transmits the vehicle data to the outside of the vehicle;
a virtual parking frame receiving unit that receives virtual parking frame data describing a position of a virtual parking frame on the map data corresponding to the vehicle data; and
a traveling route receiving unit that receives first traveling route data describing a traveling route of the vehicle in the parking space corresponding to coordinates of the virtual parking frame,
wherein the traveling route receiving unit repeatedly receives the first traveling route data between a time when the vehicle starts traveling toward the virtual parking frame in the parking space and a time when the vehicle parks in the virtual parking frame; and
a route distribution device for distributing a traveling route in a parking space in which a vehicle parks, comprising:
a reception unit that receives vehicle data describing a physical state of the vehicle;
a virtual parking frame transmitting unit that transmits virtual parking frame data describing a position of a virtual parking frame on the map data corresponding to the vehicle data to the vehicle; and
a traveling route transmitting unit that transmits traveling route data describing a traveling route of the vehicle in the parking space corresponding to coordinates of the virtual parking frame to the vehicle,
wherein the traveling route transmitting unit repeatedly transmits the traveling route data to the vehicle between a time when the vehicle starts traveling toward the virtual parking frame in the parking space and a time when the vehicle parks in the virtual parking frame.
